(19) United States
(12) Patent Application Publication
(10) Pub. No.: US 2013/0293481 A1
(43) Pub. Date: Nov. 7, 2013

(54) METHOD, ELECTRONIC DEVICE, AND COMPUTER READABLE MEDIUM FOR ACCESSING DATA FILES

(71) Applicant: Tuming You, Xiamen (CN)

(72) Inventor: Tuming You, Xiamen (CN)

(21) Appl. No.: 13/463,678

(22) Filed: May 3, 2012

(51) Int. Cl. G06F 3/041

(52) U.S. Cl. 345/173

(57) ABSTRACT

A method, electronic device, and computer readable medium involves the display of an initial state of a folder icon on a touch screen, detection of a movement path of an object in contact with the touch screen, determination that the movement path substantially matches a predetermined path shape, and the display of a three-dimensionally rotated state of the folder icon on the touch screen in response to the determination. The three-dimensionally rotated state enables user access to a lower-level icon displayed on the touch screen. The lower-level icon corresponds to an electronic data file or a subfolder containing electronic data files.

### FIELD OF THE INVENTION

This invention relates generally to graphic display and, more particularly, a method, electronic device, and computer readable medium for accessing data files.

### BACKGROUND OF THE INVENTION

With the growing popularity of portable electronic devices, there are increasing demands placed by consumers on the functionality of portable electronic devices. In response to such demands, touch sensitive displays screens have been developed. With finger taps and movements on the touch sensitive display screen, users are able to interact with portable electronic devices without a conventional push-button keyboard and mouse input device. The phrases “touch sensitive display screen,” “touch sensitive screen,” and “touch screen” are used interchangeably herein.

Most common portable electronic devices, such as smart phones and tablet personal computers have applications for organizing and accessing electronic data files, such as text documents, electronic mail (e-mail), photographic albums, individual images, videos, and executable computer programs. The electronic data files are often organized in a hierarchy of folders, so that accessing a particular electronic data files requires accessing a first layer, followed by accessing a second layer below the first layer, then accessing a third layer below the second layer, and so on. This approach can be time consuming and rather cumbersome.

What is needed is a convenient and efficient way for a user to access electronic data files with motions over a touch screen.

### SUMMARY OF THE INVENTION

Briefly and in general terms, the present invention is directed a method, an electronic device, and a computer readable medium for accessing an electronic data file or subfolder.

In aspects of the invention, a method comprises displaying an initial state of a folder icon on a touch screen of an electronic device, followed by detecting a movement path of an object in contact with the touch screen, the detecting performed by the electronic device, followed by determining that the movement path substantially matches a predetermined path shape, the determining performed by the electronic device, followed by displaying a three-dimensionally rotated state of the folder icon on the touch screen in response to the determination. The three-dimensionally rotated state enables user access to a lower-level icon displayed on the touch screen. The lower-level icon corresponds to an electronic data file or a subfolder containing electronic data files.

In other aspects, the three-dimensionally rotated state enables user access to a plurality of lower-level icons displayed on the touch screen. The lower-level icons have an appearance of being located behind the folder icon. Each lower-level icon corresponds to an electronic data file or corresponds to a subfolder containing electronic data files.

In other aspects, the lower-level icon corresponds to an electronic data file, and the method further comprises detecting a tap on the touch screen, the detecting performed by the electronic device, followed by determining that the tap is located over the lower-level icon, followed by accessing the electronic data file.

In other aspects, the lower-level icon corresponds to a subfolder, and the method further comprises detecting a second movement path on the touch screen, the detecting performed by the electronic device, followed by determining that the second movement path substantially matches the predetermined path shape, the determining performed by the electronic device, followed by displaying a three-dimensionally rotated state of the lower-level icon on the touch screen in response to the determination that the second movement path substantially matches the predetermined path shape. The three-dimensionally rotated state of the lower-level icon enables user access to a subordinate-level icon displayed on the touch screen. The subordinate level icon corresponds to an electronic data file or a subfolder containing electronic data files.

In other aspects, the method further comprises displaying a pop-up window on the touch screen in response to the determination that the movement path substantially matches the predetermined path shape. The displaying of the three-dimensionally rotated state of the folder icon includes displaying the three-dimensionally rotated state of the folder icon within the pop-up window.

In aspects of the invention, an electronic device comprises a memory device storing electronic data files, a touch screen, and a processor in signal communication with the touch screen and the memory device. The processor is configured to execute instructions to display on the touch screen an initial state of a folder icon, execute instructions to detect a movement path of an object in contact with the touch screen, execute instructions to determine that the movement path substantially matches a predetermined path shape, and execute instructions to display on the touch screen a three-dimensionally rotated state of the folder icon in response to a determination that the movement path substantially matches the predetermined path shape. The three-dimensionally rotated state enables user access to a lower-level icon displayed on the touch screen. The lower-level icon corresponds to an electronic data file or a subfolder containing electronic data files.

In other aspects of the invention, a non-transitory computer readable medium has a stored computer program embodying instructions, which when executed by a computer, causes the computer to drive a touch screen. The computer readable medium comprises instructions to display on the touch screen an initial state of a folder icon, instructions to detect a movement path of an object in contact with the touch screen, instructions to determine that the movement path substantially matches a predetermined path shape, and instructions to display on the touch screen a three-dimensionally rotated state of the folder icon in response to a determination that the movement path substantially matches the predetermined path shape. The three-dimensionally rotated state enables user access to a lower-level icon displayed on the touch screen. The lower-level icon corresponds to an electronic data file or a subfolder containing electronic data files.

The features and advantages of the invention will be more readily understood from the following detailed description which should be read in conjunction with the accompanying drawings.

### BRIEF DESCRIPTION OF THE DRAWINGS

FIG. 1 is a block diagram of an exemplary apparatus for accessing a data file.

FIG. 2 is flow diagram of an exemplary method for accessing a data file.

FIGS. 3-10 are diagrams of a touch screen displaying an initial state of a three-dimensional folder icon transformed to a rotated state of the three dimensional folder icon in response to object movement detected at an area of the touch screen over the three-dimensional folder icon.

### DETAILED DESCRIPTION OF EXEMPLARY EMBODIMENTS

As used herein, any term of approximation such as, without limitation, near, about, approximately, substantially, essentially and the like mean that the word or phrase modified by the term of approximation need not be exactly that which is written but may vary from that written description to some extent. The extent to which the description may vary will depend on how great a change can be instituted and have one of ordinary skill in the art recognize the modified version as still having the properties, characteristics and capabilities of the modified word or phrase. For example and without limitation, a first element that is described as “substantially matches” a second element encompasses a condition in which the first element perfectly matches the second element in shape or configuration, and a condition that one skilled in the art would readily recognize as a condition in which the first element matches the second element although the shape or configuration of the first and second elements are not identical.

As used herein, the phrase “three-dimensional” in reference to an image means that the image has the appearance of depth, in addition to width and height, when displayed on a substantially flat surface. A three-dimensional image can be, for example and without limitation, a perspective view, an isometric view, or an orthographic view. The phrase “three-dimensional” in reference to rotation means that the image is changed to give an appearance that the image subject has been turned around or is being viewed from a different direction. After three-dimensional rotation, a first point on the image subject can appear further away from the person viewing the image while a second point on the image subject can appear closer to the person viewing the image.

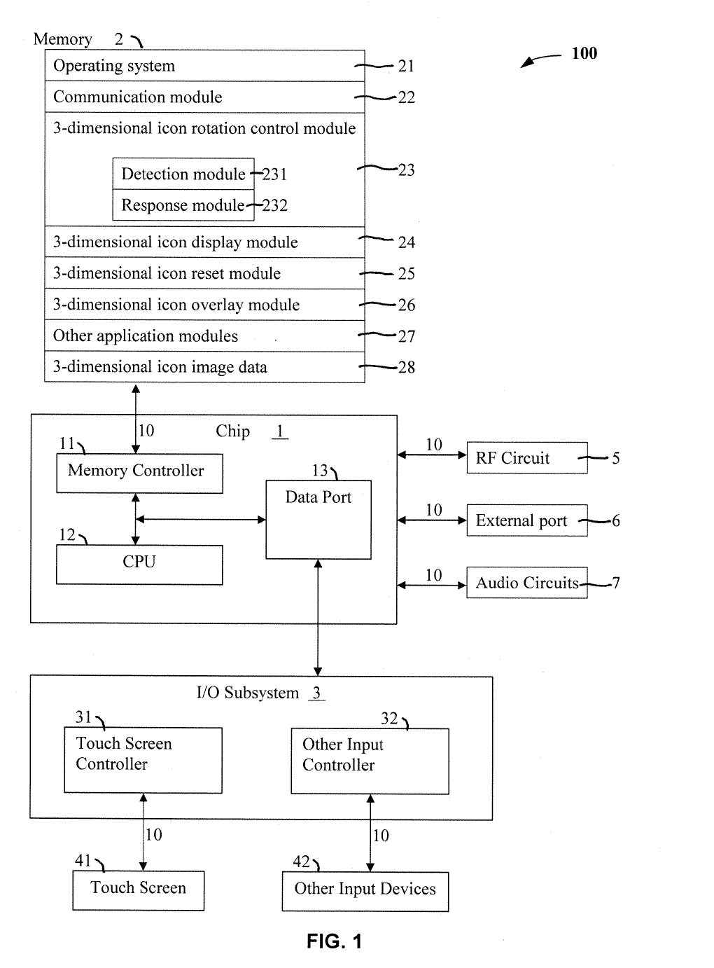

Referring now in more detail to the exemplary drawings for purposes of illustrating embodiments of the invention, wherein like reference numerals designate corresponding or like elements among the several views, there is shown in FIG. 1 an exemplary apparatus 100 for accessing an electronic data file or subfolder using touch screen 41 of the apparatus.

Apparatus 100 can be a portable device such smart phone, electronic tablet, or personal digital assistant, personal computer, or apparatus 100 can be part of a large, non-portable system. A smart phone is a mobile phone built on a mobile computing platform that allows the smart phone to have, in addition to telecommunications, any one of a combination of features including without limitation a media player, digital camera, web browser, global positioning system navigation, Wi-Fi and other wireless data communication.

Other hardware configurations for apparatus 100 are within the scope of the invention.

Referring again to FIG. 1, apparatus 100 includes chip 1, memory 2 and input/output (I/O) subsystem 3. Chip 1 includes memory controller 11, processor (CPU) 12, and peripheral interface 13. Memory 2 is a single or multiple coupled volatile (transitory) and non-volatile (non-transitory) memory devices, including without limitation magnetic disk storage devices, flash memory devices, and other non-volatile solid-state memory. Software programs and image data are stored in memory 2. Software programs include operating system 21, communication module 22, three-dimensional icon rotation control module 23, three-dimensional icon display module 24, three-dimensional icon reset display module 25, three-dimensional icon overlay module 26, other application modules 27, and three-dimensional icon image data 28. Control module 23 includes detection module 231 and response module 232. Any of the aforementioned modules and data can be stored in the volatile and/or non-volatile memory devices of memory 2.

I/O subsystem 3 includes touch screen controller 31 and other input controller 32. Chip 1 is connected to the RF circuit 5, external interface 6 and audio circuit 7. I/O subsystem 3 is connected to touch screen 41 and other input devices 42. Connections through signal bus 10 allow each of the above components to communicate with each other through any combination of a physical electrical connection and a wireless communication connection.

In alternative embodiments, any one or a combination of memory controller 11, processor 12, and peripheral interface 13 can be implemented in multiple, separate chips instead of a single chip. In some embodiments, some or all of memory 2 can be implemented on a single chip with any one or a combination of memory controller 11, processor 12, and peripheral interface 13.

Touch screen 41 is an electronic visual display configured to detect the presence, location, and movement of a physical object within the display area of the touch screen 41. The display area is that part of the touch screen 41 on which images are shown. The physical object can be a finger, a stylus, or other utensil manipulated by a person using apparatus 100. Object detection can be performed according to various technologies. Object detection can be accomplished with resistive, acoustic, infrared, near-infrared, vibratory, optical, surface capacitance, projected capacitance, mutual capacitance, and self-capacitance screen technologies. For example, detecting the presence, location, and movement of a physical object within the display area can include sensing a distortion of an electrostatic field of the screen, measurable as a change in capacitance due to physical contact with a finger or other electrical conductor. As a further example, object detection can include sensing disruption of a pattern or grid of electromagnetic beams without any need for actual physical contact with or touching of the display area.

Memory 2 stores three-dimensional icon image data 28 used to display a three-dimensional icon, such as a folder icon, on touch screen 41. Three-dimensional icon display module 24 controls the display of the three-dimensional icon on touch screen 41. Three-dimensional image rotation control module 23 includes detection module 231 and response module 232. Detection module 231 includes instructions for detecting the presence, location, and movement of a physical object in contact with, or alternatively in close proximity to, the display area of touch screen 41. Response module 232 includes instructions for making one or more images or an animation of the three-dimensional icon showing three-dimensional rotation of the icon in response to a detection made by processor 12 in conjunction with detection module 231. Processor 12 includes one or more processors configured to execute the instructions for the above-described functions. Any one or a combination of the instructions for the above-described functions and the method steps describe below may be stored in a non-volatile (non-transitory) computer readable storage medium or a random access (transitory) computer readable storage medium of memory 2 accessible for execution by processor 12.

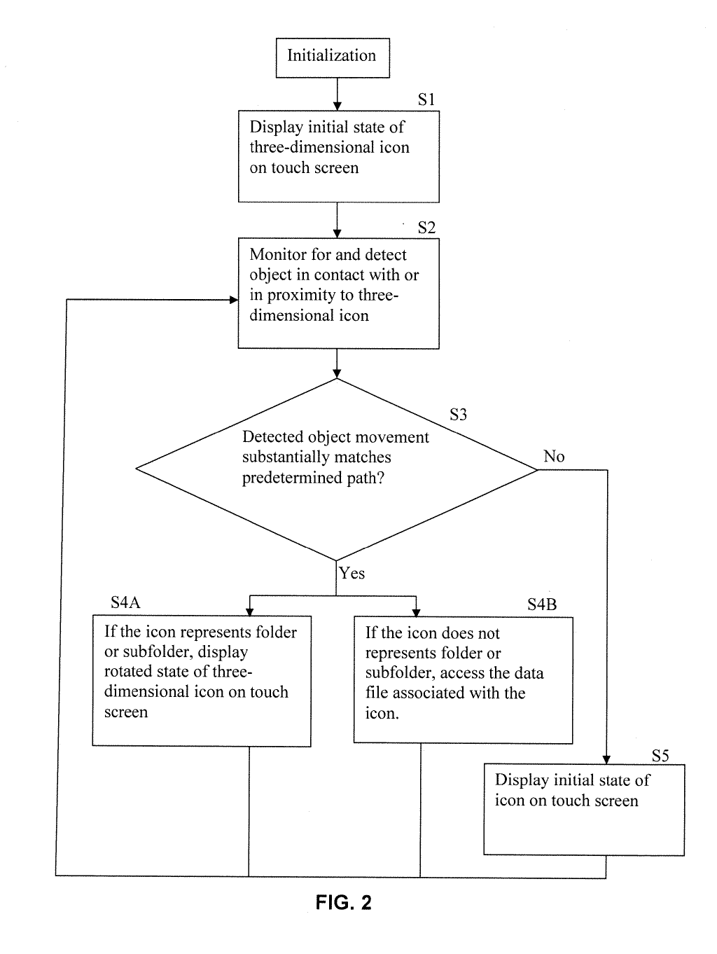

FIG. 2 shows a flow diagram of an exemplary method for accessing an electronic data file. An electronic data file can, without limitation, be a text document, e-mail, image, graphic, audio recording, video recording, multimedia, an executable computer application, and a combination thereof. Accessing the data file can include, without limitation, displaying contents of a text document or e-mail on touch screen 41, displaying an image or multimedia on touch screen 41, playing audio on audio circuits 7, executing a computer program application, and any combination thereof.

Although the exemplary method is described with reference to apparatus 100 of FIG. 1, it will be appreciated that other devices may be used to implement the method.

After initialization, processor 12 executes instructions, which may optionally be stored in non-volatile and/or random access computer readable storage media of memory 2, to allow apparatus 100 to perform the following functions. An initial state of a three-dimensional icon is displayed on touch screen 41 (block S1), which can be performed by processor 12 according to instructions in three-dimensional icon display module 24. The initial state of the icon is based on three-dimensional icon image data 28.

Next, apparatus 100 monitors for and detects a movement path (block S2) of an object in contact with the display area of touch screen 41. Detection can be performed by processor 12 according to instructions in detection module 231. Next, apparatus 100 determines whether the detected movement path satisfies criteria optionally stored in non-volatile storage media of memory 2. The criteria includes a requirement that the detected movement path substantially matches a predetermined path shape. The determination of satisfying the criteria and the subsequent response can be performed by processor 12 according to instructions in detection module 231 and response module 232.

Referring to block S3, if the criteria is met and if the icon represents a folder or subfolder, then the apparatus 100 displays a three-dimensionally rotated state of the three-dimensional icon on touch screen 41 (block S4A). The three-dimensionally rotated state of the icon is based on three-dimensional icon image data 28. The constructing and displaying of the three-dimensionally rotated state can be performed by processor 12 according to instructions in response module 232.

Referring again to block S3, if the criteria is met and if the icon does not represent a folder or subfolder, then the apparatus 100 accesses an electronic data file associated with the icon. Accessing includes, without limitation, displaying contents of a text document or e-mail on touch screen 41, playing audio on audio circuits 7, displaying an image, video, or multimedia on touch screen 41, executing a computer program application, and any combination thereof. Accessing can be performed, at least in part, according to instructions in other application modules 27.

Referring again to block S3, if the criteria is not met, the apparatus 100 does not display a three-dimensionally rotated state of the icon on touch screen 41 (block S5). In some embodiments, apparatus 100 continues to display the initial state of the icon on touch screen 41. In other embodiments, when the detected movement path satisfies other criteria—such as a tap over the icon—apparatus 100 displays a pop-up window within touch screen 41 and displays an initial state of the icon within the pop-up window.

In some embodiments, after blocks S4A, S4B, and S5, the apparatus 100 resumes by returning to block S2, to monitor for and detect another movement path of an object in contact with the display area of touch screen 41.

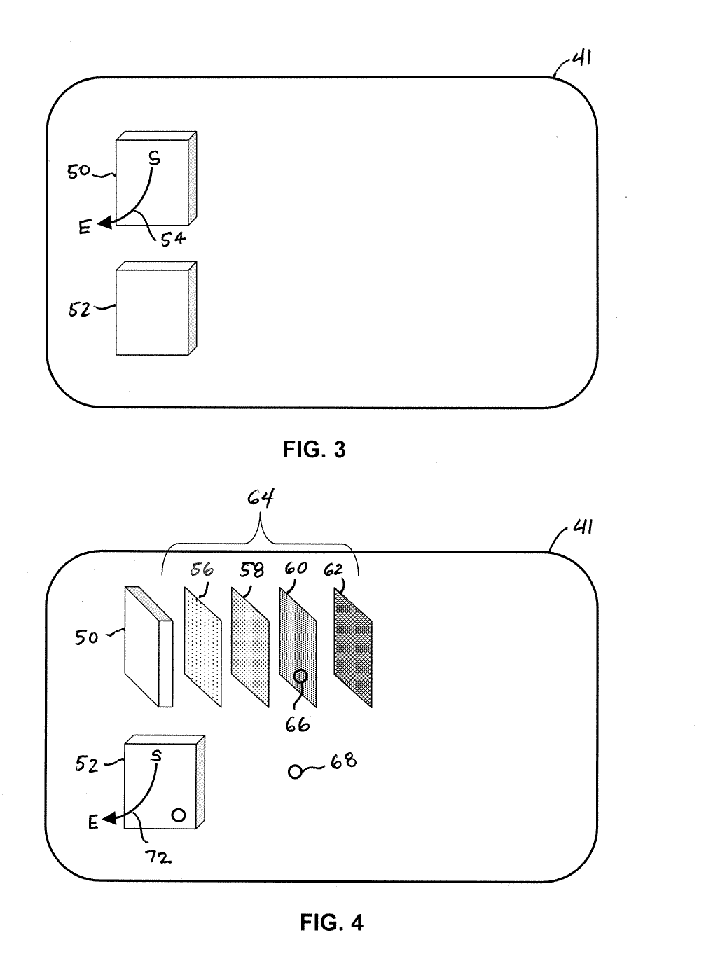

FIG. 3 shows touch screen 41 displaying first folder icon 50 and second folder icon 52. First folder icon 50 and second folder icon 52 have a three-dimensional appearance. Movement path 54 is that of an object in contact with a touch screen, such as touch screen 41 of apparatus 100. The object can be a finger of a user or a stylus or other implement manipulated by the user. Movement path 54 starts at point S and ends at point E. An electronic device, such as apparatus 100, detects movement path 54 and determines that movement path 54 satisfies predetermined criteria. The criteria includes any one or a combination of a requirement that movement path 54 traverses at least partially across any folder icon, a requirement that movement path 54 starts over any folder icon, and a requirement that movement path 54 substantially matches a predetermined path shape, for example an arc.

As shown in FIG. 4, in response to said determination that predetermined criteria is satisfied with respect to first folder icon 50, a three-dimensionally rotated state of first folder icon 50 is displayed on touch screen 41. The three-dimensionally rotated state enables user access to lower-level icon 56 displayed on touch screen 41. Lower-level icon 56 corresponds to an electronic data file or a subfolder containing electronic data files.

Still referring to FIG. 4, the three-dimensionally rotated state of first folder icon 50 enables user access to a plurality of lower-level icons 56, 58, 60, 62 displayed on touch screen 41. Lower-level icons 56, 58, 60, 62 have an appearance of being located behind first folder icon 50. Each one of lower-level icons 56, 58, 60, 62 corresponds to an electronic data file or corresponds to a subfolder containing electronic data files. Lower-level icons 56, 58, 60, 62 provide user access to electronic data files and/or subfolders within the folder represented by first folder icon 50.

Lower-level icons 56, 58, 60, 62 form an array 64. Each lower-level icon 56, 58, 60, 62 has a corresponding level rank. Each lower-level icon 56, 58, 60, 62 is displayed within array 64 in order of the corresponding level rank and in a shade or color that identifies the corresponding level rank. In some embodiments, a relatively lighter shade or color corresponds to a relatively high level rank, and a relatively darker shade or color corresponds to a relatively lower or deeper level rank.

In some embodiments, lower-level icon 60 corresponds to an electronic data file. The electronic data file is accessed when an object taps touch screen on area 66 (FIG. 4) over lower-level icon 60. Accessing the electronic data file includes, without limitation, displaying on touch screen 41 text, images, graphics, video, animation, and/or multimedia of the electronic data file; playing on audio circuits 7 audio of the electronic data file; executing a computer program of the electronic data file; and any combination thereof. Accessing the electronic data file can be performed, at least in part, according to instructions in other application modules 27 of apparatus 100.

In some embodiments, when an object subsequently taps touch screen 41 on area 68 (FIG. 4) that is not over a folder icon, first folder icon 50 is restored to its initial state (FIG. 3). First folder icon 50 can be restored to its initial state according to instructions in three-dimensional icon reset module 25 of apparatus 100.

In some embodiments, when an object subsequently taps touch screen 41 on area 70 over second folder icon 52 or when the object traces movement path 72 determined to satisfy predetermined criteria similar to those described above, first folder icon 50 is restored to its initial state (FIG. 5) and a three-dimensionally rotated state of second folder icon 52 is displayed on touch screen 41. The displaying of the three-dimensionally rotated state of second folder icon 52 includes displaying array 74 of lower-level icons 76, 78, 80, 82 on touch screen 41. As shown in FIG. 5, lower-level icons 76, 78, 80, 82 provide access to electronic data files and subfolders within the folder represented by second folder icon 52.

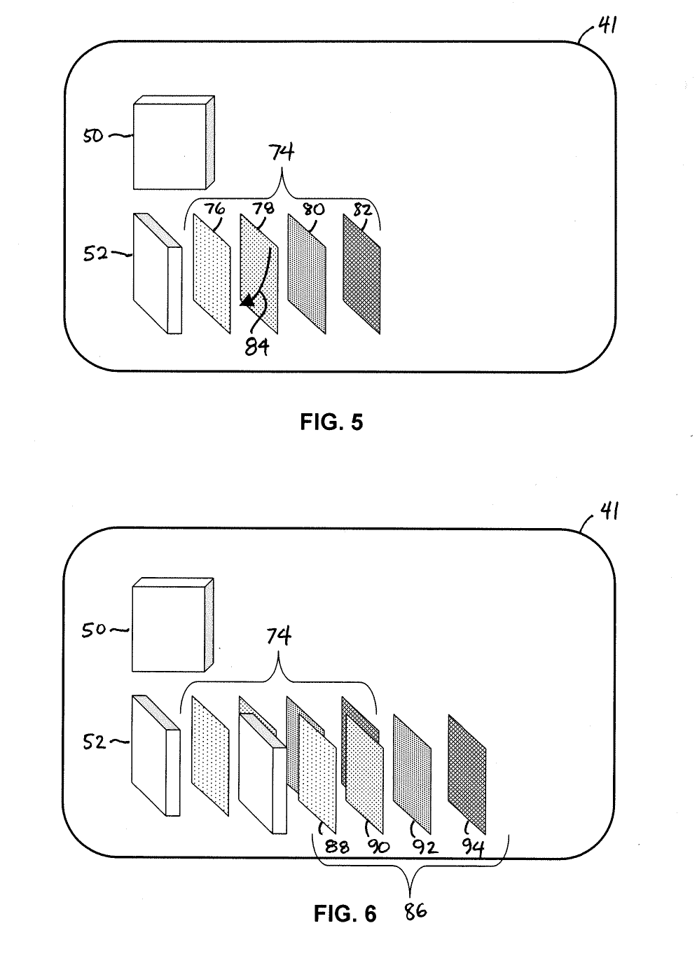

In some embodiments, lower-level icon 78 corresponds to a subfolder containing electronic data files. When an object subsequently traces second movement path 84 (FIG. 5) determined to satisfy predetermined criteria with respect to lower-level icon 78, a three-dimensionally rotated state of lower-level icon 78 is displayed (FIG. 6). As shown in FIG. 6, the displaying of the three-dimensionally rotated state of lower-level icon 78 includes displaying array 86 of lower-level icons 88, 90, 92, 94 on touch screen 41. Lower-level icons 88, 90, 92, 94 provide access to electronic data files and/or subfolders within the subfolder represented by lower-level icon 78. Lower-level icons 88, 90, 92, 94 can be referred to as subordinate-level icons since they are subordinate to lower-level icon 78.

In some embodiments, access to electronic data files and/or subfolders corresponding to subordinate-level icons 88, 90, 92, 94 is performed in substantially the same way as described for finger tap over area 66 (FIG. 4) and/or second movement path 84 (FIG. 5).

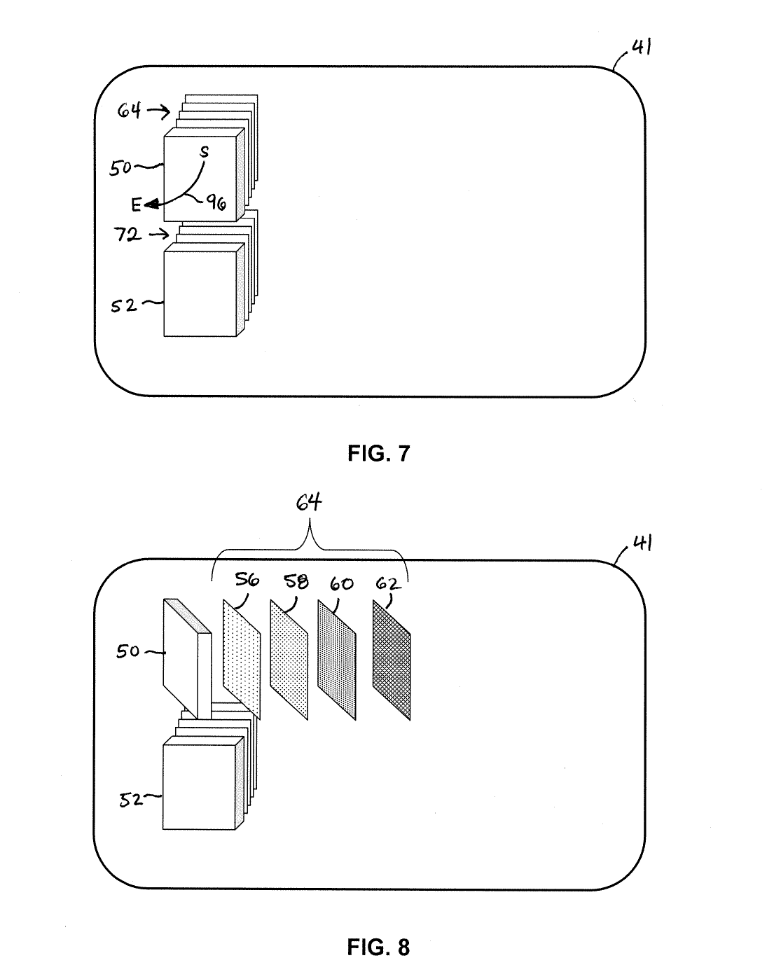

As shown in FIG. 7, in some embodiments the displaying of the initial state of folder icons 50, 52 includes displaying an initial state of arrays 64, 72 on touch screen 41. The lower-level icons within arrays 64, 72 have an appearance of being behind respective folder icons 50, 52. When an object subsequently traces movement path 96 determined to satisfy predetermined criteria with respect to first folder icon 50, a three-dimensionally rotated state of folder icon 50 and array 64 is displayed on touch screen 41. As shown in FIG. 8, the displaying a three-dimensionally rotated state of array 64 improves user access to lower-level icons 56, 58, 60, 62 compared to the initial state of array 64 shown in FIG. 7. As can be seen from a comparison of FIGS. 7 and 8, improved user access can arises from giving an appearance of ninety-degrees of rotation with respect to the initial state of array 64. Other degrees of rotation may be implemented to provide improved user access.

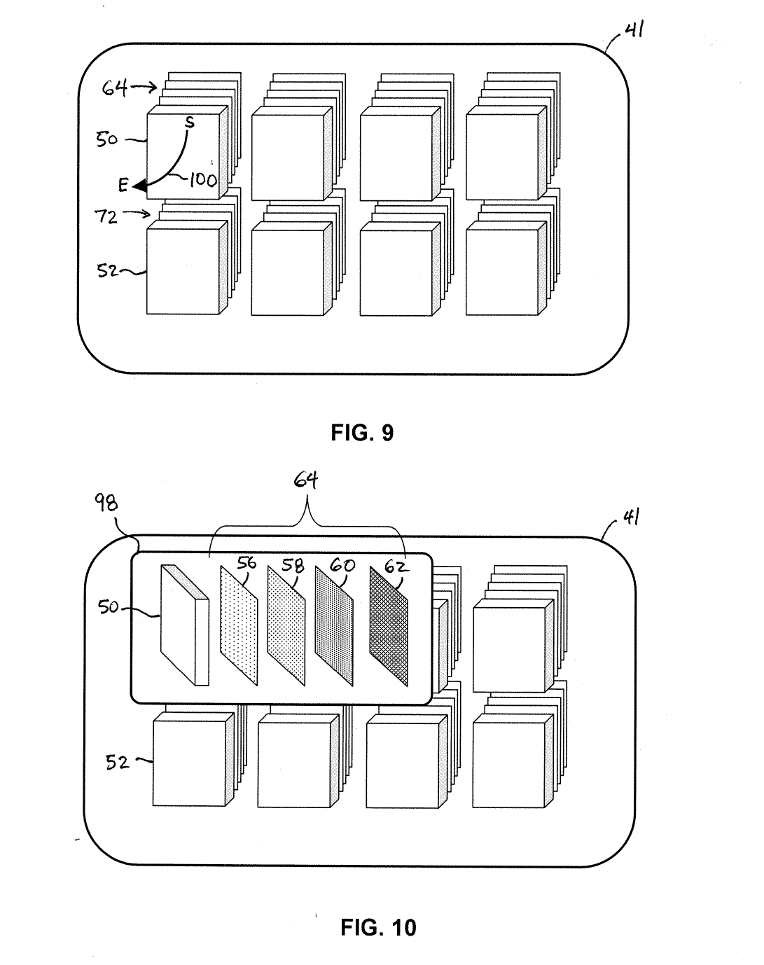

Any number of three-dimensional folder icons can be displayed on touch screen 41. For example, as shown in FIG. 9, display screen 41 can show eight top-level folder icons, among them are first folder icon 50 and second folder icon 52. The top-level folder icons are displayed with an initial state of lower-level icon arrays, among them are arrays 64 and 72.

As shown in FIG. 10, in some embodiments a pop-up window 98 is displayed on touch screen 41 in response to a determination that movement path 102 (FIG. 9) satisfies predetermined criteria. The criteria includes any one or a combination of a requirement that movement path 102 traverses at least partially across any of the top-level folder icons, a requirement that movement path 102 starts over any of the top-level folder icons, and a requirement that movement path 102 substantially matches a predetermined path shape, for example an arc.

In this case, movement path 102 traverses across and starts over first top-level icon 50. Further in response to the determination that movement path 102 traverse over first top-level icon 50, a three-dimensionally rotated state of first top-level icon 50 is displayed within pop-up window 98, and a three-dimensionally rotated state of array 64 of lower-level icons 56, 58, 60, 62 is displayed within pop-up window.

In some embodiments, access to electronic data files and/or subfolders corresponding to lower-level icons 56, 58, 60, 62 within pop-up window 98 is performed in substantially the same way as described for finger tap over area 66 (FIG. 4) and/or second movement path 84 (FIG. 5).

In some embodiments, pop-up window 98 is displayed over other top-level icons, which can be performed according to instructions in three-dimensional icon overlay module 27 of apparatus 100. The area size of pop-up window 98 is smaller than the total display area of touch screen 41. When pop-up window 98 is displayed over other top-level icons, pop-up window 98 has an appearance of lying on top of the other top-level icons. The area size of pop-up window 98 can be based on the number of lower-level icons within array 64. The area size of pop-up window 98 can increase based on the number of subordinate-level icons that may have to be displayed upon accessing a subfolder within array 64.

It will be appreciated that the present invention provides convenient finger or stylus movements to access any one of a multitude of electronic data files organized in a hierarchy of subfolders without the use of conventional keyboards, wheels, tracking balls, and mouse pointers. The present invention can thus greatly expand the functionality of smart phones, tablet PCs, other portable electronic devices.

While several particular forms of the invention have been illustrated and described, it will also be apparent that various modifications can be made without departing from the scope of the invention. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

What is claimed is:

1. A method of accessing an electronic data file or subfolder, the method comprising:
displaying an initial state of a folder icon on a touch screen of an electronic device; followed by
detecting a movement path of an object in contact with the touch screen, the detecting performed by the electronic device; followed by
determining that the movement path substantially matches a predetermined path shape, the determining performed by the electronic device; followed by
displaying a three-dimensionally rotated state of the folder icon on the touch screen in response to the determination, wherein the three-dimensionally rotated state enables user access to a lower-level icon displayed on the touch screen, the lower-level icon corresponding to an electronic data file or a subfolder containing electronic data files.

2. The method of claim 1, wherein the three-dimensionally rotated state enables user access to a plurality of lower-level icons displayed on the touch screen, the lower-level icons having an appearance of being located behind the folder icon, and each lower-level icon corresponds to an electronic data file or corresponds to a subfolder containing electronic data files.

3. The method of claim 1, wherein the lower-level icon corresponds to an electronic data file, and the method further comprises:
detecting a tap on the touch screen, the detecting performed by the electronic device; followed by
determining that the tap is located over the lower-level icon; followed by
accessing the electronic data file.

4. The method of claim 1, wherein the lower-level icon corresponds to a subfolder, and the method further comprises:
detecting a second movement path on the touch screen, the detecting performed by the electronic device; followed by
determining that the second movement path substantially matches the predetermined path shape, the determining performed by the electronic device; followed by
displaying a three-dimensionally rotated state of the lower-level icon on the touch screen in response to the determination that the second movement path substantially matches the predetermined path shape, wherein the three-dimensionally rotated state of the lower-level icon enables user access to a subordinate-level icon displayed on the touch screen, the subordinate-level icon corresponding to an electronic data file or a subfolder containing electronic data files.

5. The method of claim 1, further comprising:
displaying a pop-up window on the touch screen in response to the determination that the movement path substantially matches the predetermined path shape,
wherein the displaying of the three-dimensionally rotated state of the folder icon includes displaying the three-dimensionally rotated state of the folder icon within the pop-up window.

6. The method of claim 5, wherein the pop-up window is displayed such that the pop-up window covers only a portion of the touch screen.

7. The method of claim 1, wherein the displaying of the three-dimensionally rotated state of the folder icon includes displaying an array of lower-level icons on the touch screen, each lower-level icon having a corresponding level rank, each lower-level icon is displayed within the array in order of the corresponding level rank and in a shade or color that identifies the corresponding level rank.

8. The method of claim 1, wherein the object in contact with the touch screen is a finger, and the predetermined path shape is an arc passing over the folder icon.

9. The method of claim 1, wherein the displaying of the initial state of the folder icon includes displaying an initial state of an array of lower-level icons on the touch screen, the lower-level icons having an appearance of being behind the folder icon, and the displaying of the three-dimensionally rotated state of folder icons includes displaying a three-dimensionally rotated state of the array to improve user access to the lower-level icons compared to the initial state of the array.

10. The method of claim 1, wherein the folder icon is a first folder icon, and the method further comprises:
displaying an initial state of a second folder icon on the touch screen;
after the displaying of the three-dimensionally rotated state of the first folder icon, detecting object contact at an area of the touch screen over the second folder icon; and
in response to the detecting of the object contact, displaying the initial state of the first folder icon and a three-dimensionally rotated state of the second folder icon on the touch screen.

11. An electronic device for accessing an electronic data file or subfolder, the electronic device comprising:
a memory device storing electronic data files;
a touch screen; and
a processor in signal communication with the touch screen and the memory device, the processor configured to
execute instructions to display on the touch screen an initial state of a folder icon,
execute instructions to detect a movement path of an object in contact with the touch screen,
execute instructions to determine that the movement path substantially matches a predetermined path shape, and
execute instructions to display on the touch screen a three-dimensionally rotated state of the folder icon in response to a determination that the movement path substantially matches the predetermined path shape, wherein the three-dimensionally rotated state enables user access to a lower-level icon displayed on the touch screen, the lower-level icon corresponding to an electronic data file or a subfolder containing electronic data files.

12. The electronic device of claim 11, wherein the instructions to display the three-dimensionally rotated state includes instructions to display a plurality of lower-level icons on the touch screen, the lower-level icons having an appearance of being located behind the folder icon, and each lower-level icon corresponds to one of the electronic data files stored in the memory device or corresponds to a subfolder for accessing at least one of the electronic data files stored in the memory device.

13. The electronic device of claim 11, wherein the processor is further configured to execute instructions to display a pop-up window on the touch screen in response to the determination that the movement path substantially matches the predetermined path shape, and wherein the processor is further configured to display the three-dimensionally rotated state of the folder icon within the pop-up window.

14. A non-transitory computer readable medium having a stored computer program embodying instructions, which when executed by a computer, causes the computer to drive a touch screen, the computer readable medium comprising:
instructions to display on the touch screen an initial state of a folder icon,
instructions to detect a movement path of an object in contact with the touch screen,
instructions to determine that the movement path substantially matches a predetermined path shape, and
instructions to display on the touch screen a three-dimensionally rotated state of the folder icon in response to a determination that the movement path substantially matches the predetermined path shape, wherein the three-dimensionally rotated state enables user access to a lower-level icon displayed on the touch screen, the lower-level icon corresponding to an electronic data file or a subfolder containing electronic data files.

15. The computer readable medium of claim 14, wherein the instructions to display the three-dimensionally rotated state includes instructions to display a plurality of lower-level icons on the touch screen, the lower-level icons having an appearance of being located behind the folder icon, and each lower-level icon corresponds to an electronic data file or corresponds to a subfolder for accessing electronic data files.

16. The computer readable medium of claim 14, further comprising instructions to display a pop-up window on the touch screen in response to A determination that the movement path substantially matches the predetermined path shape, and wherein the instructions to display the three-dimensionally rotated state of the folder icon includes instructions to display the three-dimensionally rotated state of the folder icon within the pop-up window.
